(19) United States
(12) Patent Application Publication
(10) Pub. No.: US 2023/0154163 A1
(43) Pub. Date: May 18, 2023

(54) METHOD AND ELECTRONIC DEVICE FOR RECOGNIZING CATEGORY OF IMAGE, AND STORAGE MEDIUM

(71) Applicant: BEIJING BAIDU NETCOM SCIENCE TECHNOLOGY CO., LTD., Beijing (CN)

(72) Inventors: Zhuang Jia, Beijing (CN); Xiang Long, Beijing (CN); Yan Peng, Beijing (CN); Honghui Zheng, Beijing (CN); Bin Zhang, Beijing (CN); Yunhao Wang, Beijing (CN); Ying Xin, Beijing (CN); Chao Li, Beijing (CN); Xiaodi Wang, Beijing (CN); Song Xue, Beijing (CN); Yuan Feng, Beijing (CN); Shumin Han, Beijing (CN)

(73) Assignee: BEIJING BAIDU NETCOM SCIENCE TECHNOLOGY CO., LTD., Beijing (CN)

(21) Appl. No.: 18/151,108

(22) Filed: Jan. 6, 2023

Related U.S. Application Data
(63) Continuation of application No. PCT/CN2022/074927, filed on Jan. 29, 2022.

(30) Foreign Application Priority Data
Apr. 29, 2021 (CN) 202110474802.6

(51) Int. Cl. G06V 10/774; G06V 10/58; G06V 10/764; G06V 10/776; G06V 20/70; G06V 10/77

(52) U.S. Cl. CPC G06V 10/774; G06V 10/58; G06V 10/764; G06V 10/776; G06V 20/70; G06V 10/7715

(57) ABSTRACT

A method for recognizing a category of an image includes: acquiring a spectral image; training an image recognition model based on the spectral image, in which the image recognition model acquires a spectral semantic feature of each pixel, a minimum distance between each pixel and each category, and a spectral distance between a first spectrum of each pixel and a second spectrum of each category; splices them; and performs classification and recognition based on the spliced feature to output a recognition probability of each pixel under each category; determining a loss function of the image recognition model, adjusting the image recognition model based on the loss function, and returning to training the adjusted image recognition model based on the spectral image until training ends; recognizing a maximum recognition probability, output from a target image recognition model, and using a category corresponding to the maximum recognition probability as a target category.

### CROSS-REFERENCE TO RELATED APPLICATION

This application is a continuation of International Application No. PCT/CN2022/074927, filed on Jan. 29, 2022, which claims priority to Chinese Patent Application No. 202110474802.6 filed on Apr. 29, 2021, the entire content of which is incorporated herein by reference.

### TECHNICAL FIELD

The disclosure relates to the field of computer technologies, and in particular to, a method for recognizing a category of an image, an electronic device, and a storage medium.

### BACKGROUND

Currently, spectral images have been widely used in geographic surveying and mapping, land usage monitoring, urban planning, and other fields. In particular, hyperspectral images are widely used in image category recognition due to their large number of frequency bands, wide spectrum range, rich ground object information, and other feature information.

### SUMMARY

According to a first aspect, a method for recognizing a category of an image is provided, including: acquiring a spectral image, in which the spectral image includes a first pixel that is to be recognized and second pixels that correspond to each category and are marked as samples; training an image recognition model based on the spectral image, in which the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category; determining a loss function of the image recognition model based on recognition probabilities of the second pixels, adjusting the image recognition model based on the loss function, and returning to training the adjusted image recognition model based on the spectral image until training ends to generate a target image recognition model; recognizing a maximum recognition probability among recognition probabilities of the first pixel under each category, output from the target image recognition model, and using a category corresponding to the maximum recognition probability as a target category corresponding to the first pixel.

According to a second aspect, an electronic device is provided, including: at least one processor; and a memory communicatively connected with the at least one processor; in which the memory is configured to store instructions executable by the at least one processor, and the at least one processor is configured to execute the instructions to perform the method for recognizing a category of an image according to the first aspect of the disclosure.

According to a third aspect, a non-transitory computer-readable storage medium storing computer instructions is provided, in which the computer instructions are configured to cause a computer to execute the method for recognizing a category of an image according to the first aspect of the disclosure.

It should be understood that the content described in this section is not intended to identify key or important features of embodiments of the disclosure, nor is it intended to limit the scope of the disclosure. Other features of the disclosure will be easily understood through the following description.

### BRIEF DESCRIPTION OF THE DRAWINGS

The accompanying drawings are used to better understand the disclosure, and do not constitute a limitation to the disclosure, in which:

FIG. 1 is a flowchart of a method for recognizing a category of an image according to a first embodiment of the disclosure.

FIG. 2 is a flowchart of acquiring a minimum distance between each pixel and each category in a method for recognizing a category of an image according to a second embodiment of the disclosure.

FIG. 3 is a flowchart of acquiring a spectral distance between a first spectrum of each pixel and a second spectrum of each category in a method for recognizing a category of an image according to a third embodiment of the disclosure.

FIG. 4 is a flowchart of acquiring a vector distance between a first spectrum of each pixel and an average value of second spectra of each category in a method for recognizing a category of an image according to a fourth embodiment of the disclosure.

FIG. 5 is a schematic diagram of an image recognition model in a method for recognizing a category of an image according to a fifth embodiment of the disclosure.

FIG. 6 is a block diagram of an apparatus for recognizing a category of an image according to a first embodiment of the disclosure.

FIG. 7 is a block diagram of an electronic device for implementing a method recognizing a category of an image according to an embodiment of the disclosure.

### DETAILED DESCRIPTION

The following describes embodiments of the disclosure with reference to the accompanying drawings, which include various details of the embodiments of the disclosure to facilitate understanding and should be considered merely exemplary. Therefore, those skilled in the art should recognize that various changes and modifications can be made to the embodiments described herein without departing from the scope and spirit of the disclosure. Likewise, for clarity and conciseness, descriptions of well-known functions and structures are omitted in the following description.

Artificial intelligence (AI) is a technical science that studies and develops theories, methods, technologies, and application systems used to simulate, extend, and expand human intelligence. At present, AI technologies have advantages of high degree of automation, high accuracy, and low cost, which have been widely used.

Computer Vision refers to using cameras and computers instead of human eyes to identify, track, and measure targets, and to further perform graphics processing, so that the images after computer processing can become images more suitable for human eyes to observe or for transmission to instruments for detection. Computer vision is a comprehensive subject, including computer science and engineering, signal processing, physics, applied mathematics and statistics, neurophysiology, and cognitive science.

Deep learning (DL) is a new research direction in the field of machine learning (ML). It is to learn internal laws and representation levels of sample data to enable machines to have the same analytical learning ability as people, and to be able to recognize words, images, sounds and other data, which is widely used in speech and image recognition.

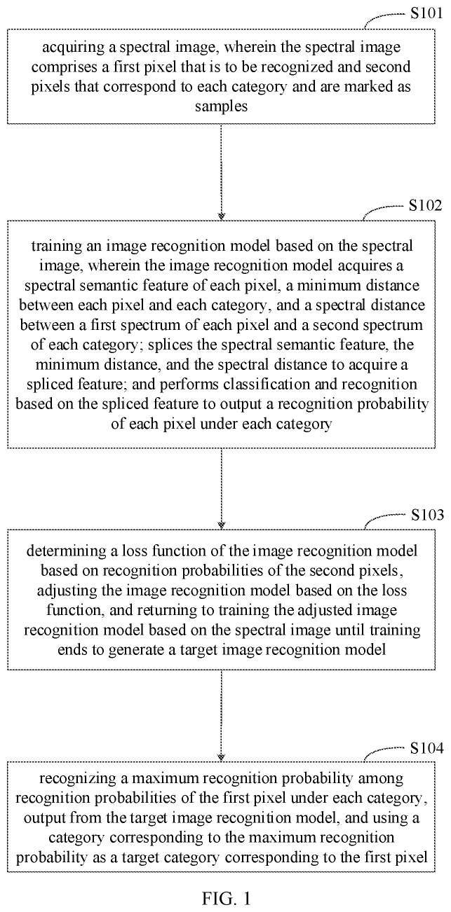

FIG. 1 is a flowchart of a method for recognizing a category of an image according to a first embodiment of the disclosure.

As illustrated in FIG. 1, the method for recognizing a category of an image according to the first embodiment of the disclosure includes the following.

S101, a spectral image is acquired, in which the spectral image includes a first pixel that is to be recognized and second pixels that correspond to each category and are marked as samples.

It should be noted that an execution subject of the method for recognizing a category of an image in embodiments of the disclosure may be a hardware device with data information processing capabilities and/or necessary software to drive the hardware device to work. Optionally, the execution subject may include a workstation, a server, a computer, a user terminal, or other smart device. The user terminal includes, but is not limited to, a mobile phone, a computer, a smart voice interaction device, a smart home appliance, a vehicle-mounted terminal, and the like.

In embodiments of the disclosure, the spectral image may be acquired, for example, the spectral image may be a hyperspectral image. Optionally, the spectral image can be acquired by a spectral sensor.

In embodiment of the disclosures, the spectral image includes the first pixel that is to be recognized and the second pixels corresponding to each category and marked as the samples. It should be noted that the first pixel to be recognized refers to a pixel that is not marked as a sample, and the category refers to the recognition category corresponding to the pixel, which are not limited herein. For example, the number of categories can be c, including but not limited to grass, building, lake, etc., and the number of second pixels marked as samples corresponding to each category may be k, where c and k are both positive integers, which can be set according to actual situations, and there is no excessive limitation herein.

S102, an image recognition model is trained based on the spectral image, in which the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category

In embodiments of the disclosure, the spectral semantic feature of each pixel, the minimum distance between each pixel and each category, and the spectral distance between the first spectrum of each pixel and the second spectrum of each category can be acquired by the image recognition model. It is to be understood that, the spectral semantic feature of each pixel can represent the spectral information of each pixel, the minimum distance between each pixel and each category can represent the spatial information between each pixel and each category, and the spectral distance between the first spectrum of each pixel and the second spectrum of each category may represent the spectral information between the first spectrum of each pixel and the second spectrum of each category.

Optionally, the number of spectral bands for each pixel may be b.

Optionally, the number of spectral semantic features of each pixel may be m.

There, b and m are both positive integers, which can be set according to actual situations, and there is no excessive limitation herein.

It can be understood that the number of minimum distances corresponding to each pixel may be c, and the number of spectral distances corresponding to each pixel may be c, where c is the number of categories.

Further, the spectral semantic feature, minimum distance, and spectral distance can be spliced to acquire the spliced feature, and classification and recognition are performed based on the spliced feature, and the recognition probability of each pixel under each category is output. Therefore, the method can make full use of the spectral information of the pixel, the spatial information between the pixel and each category, and the spectral information between the first spectrum of the pixel and the second spectrum of each category, to acquire the recognition probability of each pixel under each category.

Optionally, splicing the spectral semantic feature, minimum distance, and spectral distance may include horizontal splicing of the spectral semantic feature, minimum distance, and spectral distance. For example, if the spectral semantic feature of pixel a is F1, the minimum distance between pixel a and category d is F2, and the spectral distance between the first spectrum of pixel a and the second spectrum of category d is F3, [F1, F2, F3] is used as the splicing feature, classification and recognition are performed based on [F1, F2, F3], and the recognition probability of pixel a in category d is output.

S103, a loss function of the image recognition model is determined based on recognition probabilities of the second pixels, the image recognition model is adjusted based on the loss function, and it returns to training the adjusted image recognition model based on the spectral image until training ends to generate a target image recognition model.

In embodiments of the disclosure, the loss function of the image recognition model can be determined based on the recognition probabilities of the second pixels. The recognition probabilities of the second pixels may include the recognition probabilities of the second pixels under each category.

Optionally, determining the loss function of the image recognition model based on the recognition probabilities of the second pixels may include: recognizing a maximum recognition probability from the recognition probabilities of the second pixels under each category, and assigning the category corresponding to the maximum recognition probability as the predicted category corresponding to the second pixels, and the loss function of the image recognition model is determined according to the predicted category corresponding to the second pixels and the true category marked. For example, the loss function can be a cross-entropy loss function, and the corresponding formula is as follows:

Loss=CrossEntropy(P1,P2)

where, P1 is the predicted category corresponding to the second pixels, and P2 is the actual category marked for the second pixels.

Further, the image recognition model can be adjusted based on the loss function, and the image recognition model after the adjustment can be continuously trained based on the spectral image until the end of the training to generate the target image recognition model.

For example, parameters of the image recognition model can be adjusted based on the loss function, and it may return to continue training the adjusted image recognition model based on the spectral image until the number of iterations reaches the preset number threshold, or the model accuracy reaches the preset accuracy threshold. Thus, the training can be ended to generate the target image recognition model. The preset number threshold and the preset accuracy threshold can be set according to actual conditions.

S104, a maximum recognition probability is recognized among recognition probabilities of the first pixel under each category, output from the target image recognition model, and a category corresponding to the maximum recognition probability is used as a target category corresponding to the first pixel.

In embodiments of the disclosure, after the target image recognition model is generated, the spectral semantic feature of the first pixel, the minimum distance between the first pixel and each category, and the spectral distance between the first spectrum of the first pixel and the second spectrum of each category, are acquired by the target image recognition model. The spectral semantic feature, minimum distance and spectral distance are spliced to acquire the splicing feature, and classification and recognition are performed based on the splicing feature, and the recognition probability of the first pixel in each category is output.

Further, the maximum recognition probability among the recognition probabilities of the first pixel under each category output from the target image recognition model can be recognized, and the category corresponding to the maximum recognition probability is determined as the target category corresponding to the first pixel. Thus, the category corresponding to the maximum recognition probability among the recognition probabilities corresponding to the first pixel can be determined as the target category corresponding to the first pixel.

For example, categories include d, e, and f, and the recognition probabilities of the first pixel a in categories d, e, and f are P_{d}, Pₑ, and P_{f} respectively, and the maximum value of P_{d}, Pₑ, and Pf is P_{d}, then the category d corresponding to P_{d} is determined as the target category corresponding to the first pixel a.

In summary, the method for recognizing a category of an image according to embodiments of the disclosure can make full use of the spectral information of the pixel, the spatial information between the pixel and each category, and the spectral information between the first spectrum of the pixel and the second spectrum of each category, to acquire the recognition probabilities of the pixel in each category, and the category corresponding to the maximum recognition probability is determined as the category corresponding to the pixel. In addition, the image recognition model can be trained according to the second pixels marked as the samples corresponding to each category, and the number of samples required is small, and the annotation cost is low.

On the basis of any of the above embodiments, acquiring the spectral semantic feature of each pixel in step S102 may include: inputting the spectral image into a semantic extraction layer of the image recognition model, and performing semantic feature extraction on a spectrum of each pixel based on the semantic extraction layer to acquire the spectral semantic feature.

In embodiments of the disclosure, the image recognition model may include the semantic extraction layer, for example, the semantic extraction layer may be a convolutional neural network (CNN).

Therefore, the method can extract the semantic feature of the spectrum of each pixel through the semantic extraction layer of the image recognition model to acquire the spectral semantic feature.

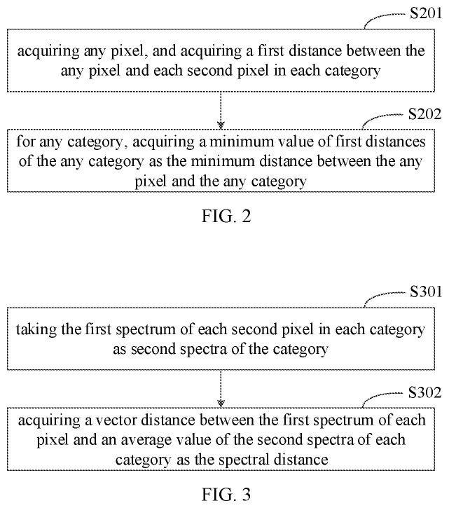

On the basis of any of the above embodiments, as shown in FIG. 2, acquiring the minimum distance between each pixel and each category in step S102 includes the following.

S201, any pixel is acquired, and a first distance between the any pixel and each second pixel in each category is acquired.

In embodiments of the disclosure, the first distance between the any pixel and each second pixel included in each category can be acquired. The number of the first distances corresponding to the any pixel and each category can be k, where k is the number of second pixels included in each category.

For example, the first position of the any pixel and the second position of the second pixel can be acquired, and the first distance between the any pixel and the second pixel can be acquired according to the first position and the second position. The position includes but is not limited to coordinates of the pixel on the spectral image.

Optionally, the first distance includes but is not limited to a Euclidean distance, a Manhattan distance, etc., which is not limited herein.

S202, for any category, a minimum value of first distance of the any category is acquired as the minimum distance between the any pixel and the any category.

In embodiments of the disclosure, for the any category, the minimum value of the first distances of the any category can be acquired as the minimum distance between the any pixel and the any category.

For example, if the category d includes the second pixels g, h, and l, the first distances between the pixel a and the second pixels g, h, and l are d_{g}, dₕ, dₗ, and the minimum value among d_{g}, dₕ, dₗ is dₗ, and dₗ can be used as the minimum distance between pixel a and category d.

Therefore, the method can acquire the first distance between any pixel and each second pixel contained in each category, and acquire the minimum value of the first distances of any category as the distance between any pixel and this category, to acquire the minimum distance between each pixel and each category.

On the basis of any of the above embodiments, as shown in FIG. 3, acquiring the spectral distance between the first spectrum of each pixel and the second spectrum of each category in step S102 may include the following.

S301, the first spectrum of each second pixel in each category is used as second spectra of the category.

In embodiments of the disclosure, the first spectrum of each second pixel included in each category is taken as the second spectra of the category. For example, the category d includes the second pixels g, h, and l, and the first spectra h_{g}, hₕ, and hₗ of the second pixels g, h, and l can be used as the second spectra of the category d.

S302, a vector distance between the first spectrum of each pixel and an average value of the second spectra of each category is acquired and used as the spectral distance.

It is to be understood that the number of spectral bands of each pixel can be b, and the first spectrum of each pixel and the average value of the second spectra of each category can be a b-dimensional vector, where b is a positive integer, which can be set according to actual situations, and there is no too much limitation herein.

In embodiments of the disclosure, the vector distance between the first spectrum of each pixel and the average value of the second spectra of each category can be acquired, and the vector distance is regarded as the spectral distance.

Optionally, the vector distance includes but is not limited to a Euclidean distance, etc., which is not limited herein.

Therefore, the method can use the first spectrum of each second pixel contained in each category as the second spectra of the category, and acquire the vector distance between the first spectrum of each pixel and the average value of the second spectra of each category and use it as the spectral distance to acquire the spectral distance between the first spectrum of each pixel and the second spectrum of each category.

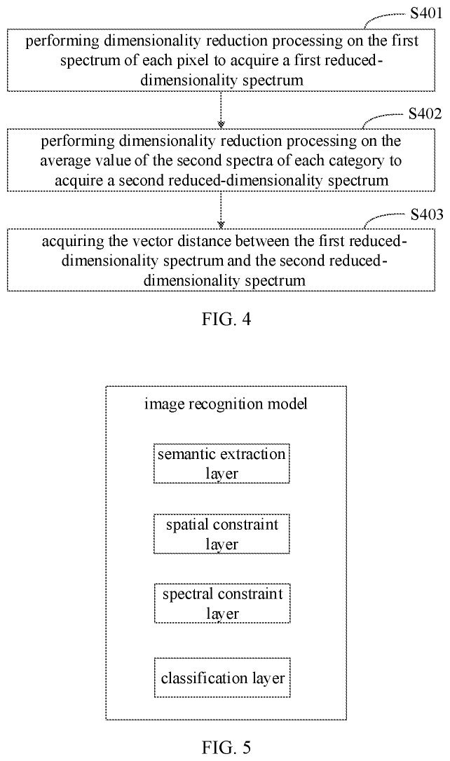

On the basis of any of the above embodiments, as shown in FIG. 4, acquiring the vector distance between the first spectrum of each pixel and the average value of the second spectra of each category as the spectral distance in step S302 may include the following.

S401, dimensionality reduction processing is performed on the first spectrum of each pixel to acquire a first reduced-dimensionality spectrum.

S402, dimensionality reduction processing is performed on the average value of the second spectra of each category to acquire a second reduced-dimensionality spectrum.

In embodiments of the disclosure, the dimensionality reduction processing is performed on the first spectrum of each pixel and the average value of the second spectra of each category respectively to acquire the first reduced-dimensionality spectrum and the second reduced-dimensionality spectrum.

Optionally, principal component analysis (PCA) processing is performed on the spectrum to extract a principal component from the spectrum to generate a reduced-dimensionality spectrum; in which the spectrum includes the first spectrum and the second spectrum, and the reduced-dimensionality spectrum includes the first reduced-dimensionality spectrum and the second reduced-dimensionality spectrum. Thus, the dimensionality reduction processing of the spectrum can be performed through PCA processing to generate the first reduced-dimensionality spectrum and the second reduced-dimensionality spectrum.

Optionally, bands corresponding to the spectrum are acquired, the bands are filtered, a target band is reserved, and a reduced-dimensionality spectrum is generated based on a spectrum on the target band. In this way, the spectrum can be reduced in dimensionality by filtering the bands, and the reduced-dimensional spectrum can be generated according to the spectrum on the reserved target band.

S403, the vector distance between the first reduced-dimensionality spectrum and the second reduced-dimensionality spectrum is acquired.

Therefore, the method can perform the dimensionality reduction processing on the first spectrum of each pixel and the average value of the second spectra of each category respectively to acquire the first reduced-dimensionality spectrum and the second reduced-dimensionality spectrum, and acquire the vector distance between the first spectrum of each pixel and the average value of the second spectra of each category.

On the basis of any of the above embodiments, as shown in FIG. 5, the image recognition model includes a semantic extraction layer, a spatial constraint layer, a spectral constraint layer, and a classification layer. The semantic extraction layer is used to acquire the spectral semantic features of each pixel, the spatial constraint layer is used to acquire the minimum distance between each pixel and each category, the spectral constraint layer is used to acquire the spectral distance between the first spectrum of each pixel and the second spectrum of each category, and the classification layer is used to splice the spectral semantic features, the minimum distance, and the spectral distance to acquire the spliced feature, and perform classification and recognition based on the spliced feature to acquire the recognition probability of each pixel under each category, and recognize the maximum recognition probability from the recognition probabilities of pixels under each category, and determine the category corresponding to the maximum recognition probability as the target category corresponding to the pixel, and output the target category corresponding to the pixel.

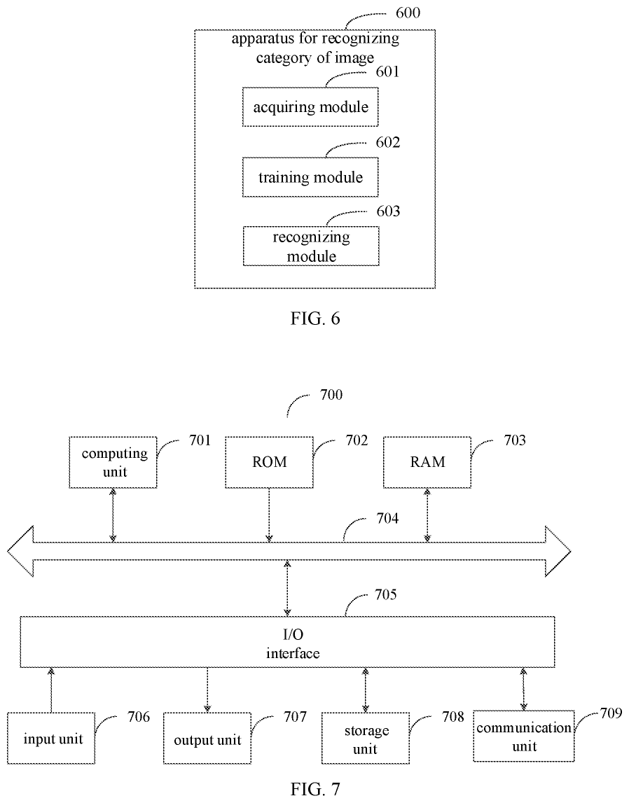

FIG. 6 is a block diagram of an apparatus for recognizing a category of an image according to a first embodiment of the disclosure.

As shown in FIG. 6, the apparatus 600 for recognizing a category of an image in embodiments of the disclosure includes: an acquiring module 601, a training module 602, and a recognizing module 603.

The acquiring module 601 is configured to acquire a spectral image, in which the spectral image includes a first pixel that is to be recognized and second pixels that correspond to each category and are marked as sample.

The training module 602 is configured to train an image recognition model based on the spectral image, in which the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category.

The training module 602 is further configured to determine a loss function of the image recognition model based on recognition probabilities of the second pixels, adjust the image recognition model based on the loss function, and return to train the adjusted image recognition model based on the spectral image until training ends to generate a target image recognition model.

The recognizing module 603 is configured to recognize a maximum recognition probability among recognition probabilities of the first pixel under each category output from the target image recognition model, and use a category corresponding to the maximum recognition probability as a target category corresponding to the first pixel.

In an embodiment of the disclosure, the training module 602 includes: an extraction unit, configured to input the spectral image into a semantic extraction layer of the image recognition model, and perform semantic feature extraction on a spectrum of each pixel based on the semantic extraction layer to acquire the spectral semantic feature.

In an embodiment of the disclosure, the training module 602 includes: a first acquisition unit, configured to acquire any pixel, and acquiring a first distance between the any pixel and each second pixel in each category; the first acquiring unit is further configured to, for any category, acquire a minimum value of first distances of the any category as the minimum distance between the any pixel and the any category.

In an embodiment of the disclosure, the training module 602 includes: a second acquisition unit, configured to take the first spectrum of each second pixel in each category as second spectra of the category; the second acquiring unit is further configured to acquire a vector distance between the first spectrum of each pixel and an average value of the second spectra of each category as the spectral distance.

In an embodiment of the disclosure, the second acquisition unit includes: a dimensionality reduction subunit, configured to perform dimensionality reduction processing on the first spectrum of each pixel to acquire a first reduced-dimensionality spectrum; the dimensionality reduction subunit is also configured to perform dimensionality reduction processing on the average value of the second spectra of each category to acquire a second reduced-dimensionality spectrum; an acquiring subunit is configured to acquire the vector distance between the first reduced-dimensionality spectrum and the second reduced-dimensionality spectrum.

In an embodiment of the disclosure, the dimensionality reduction subunit is specifically configured to: perform principal component analysis (PCA) processing on the spectrum to extract a principal component from the spectrum to generate a reduced-dimensionality spectrum; in which the spectrum includes the first spectrum and the second spectrum, and the reduced-dimensionality spectrum includes the first reduced-dimensionality spectrum and the second reduced-dimensionality spectrum; or, acquire bands corresponding to the spectrum, filter the bands, reserve a target band, and generate a reduced-dimensionality spectrum based on a spectrum on the reserved target band.

In summary, the apparatus for recognizing a category of an image according to embodiments of the disclosure can make full use of the spectral information of the pixel, the spatial information between the pixel and each category, and the spectral information between the first spectrum of the pixel and the second spectrum of each category, to acquire the recognition probabilities of the pixel in each category, and the category corresponding to the maximum recognition probability is determined as the category corresponding to the pixel. In addition, the image recognition model can be trained according to the second pixels marked as the samples corresponding to each category, and the number of samples required is small, and the annotation cost is low.

According to embodiments of the disclosure, the disclosure also provides an electronic device, a readable storage medium, and a computer program product.

FIG. 7 is a block diagram of an electronic device 700 that is used to implement the method for recognizing a category of an image of embodiments of the disclosure. An electronic device is intended to represent various forms of digital computers, such as laptops, desktops, workstations, personal digital assistants, servers, blade servers, mainframes, and other suitable computers. An electronic device may also represent various forms of mobile apparatuses, such as personal digital processing, cellular telephones, smart phones, wearable devices, and other similar computing apparatuses. The components shown herein, their connections and relationships, and their functions, are by way of example only, and are not intended to limit implementations of the disclosure described and/or claimed herein.

As shown in FIG. 7, a device 700 includes a computing unit 701 that can perform various appropriate actions and processes according to a computer program stored in a read-only memory (ROM) 702 or a computer program loaded from a storage unit 708 into a random access memory (RAM) 703. In the RAM 703, various programs and data necessary for the operation of the device 700 can also be stored. The computing unit 701, the ROM 702, and the RAM 703 are connected to each other through a bus 704. An input/output (I/O) interface 705 is also connected to the bus 704.

Multiple components in the device 700 are connected to the I/O interface 705, including: an input unit 706, such as a keyboard, a mouse, etc.; an output unit 707, such as various types of displays, speakers, etc.; a storage unit 708, such as a magnetic disk, an optical disk, and the like; and a communication unit 709, such as a network card, a modem, a wireless communication transceiver, and the like. The communication unit 709 allows the device 700 to exchange information/data with other devices through a computer network such as the Internet and/or various telecommunication networks.

The computing unit 701 may be various general-purpose and/or special-purpose processing components having processing and computing capabilities. Some examples of the computing unit 701 include, but are not limited to, central processing units (CPUs), graphics processing units (GPUs), various dedicated artificial intelligence (AI) computing chips, various computing units that run machine learning model algorithms, digital signal processing processor (DSP), and any suitable processors, controllers, microcontrollers, and the like. The computing unit 701 executes various methods and processes described above, such as the methods in FIG. 1 to FIG. 4. For example, in some embodiments, the method may be implemented as computer software programs, which are tangibly included in a machine-readable medium, such as the storage unit 708. In some embodiments, part or all of the computer programs can be loaded and/or installed on the device 700 via the ROM 702 and/or the communication unit 709. When the computer program is loaded into the RAM 703 and executed by the computing unit 701, one or more steps of the method described above may be executed. Alternatively, in other embodiments, the computing unit 701 may be configured to execute the training method for a human body attribute detection model or the human body attribute recognition method in any other appropriate manner (for example, by means of firmware).

Various embodiments of the systems and techniques described above herein can be implemented in digital electronic circuit systems, integrated circuit systems, field programmable gate arrays (FPGAs), application specific integrated circuits (ASICs), application specific standard products (ASSPs), system of System-On-Chip (SOC), Load Programmable Logic Device (CPLD), computer hardware, firmware, software, and/or combinations thereof. These various embodiments may include: being implemented in one or more computer programs, which can be executed and/or interpreted on a programmable system including at least one programmable processor, and the programmable processor may be a special-purpose or a general-purpose programmable processor, can receive data and instructions from a storage system, at least one input device, and at least one output device, and transmit data and instructions to this storage system, this at least one input device, and this at least one output device.

Program codes for implementing the training method for a human body attribute detection model or the human body attribute recognition method of the disclosure may be written in any combination of one or more programming languages. These program codes may be provided to a processor or a controller of a general-purpose computer, a special purpose computer, or other programmable data processing devices, so that the program codes, when executed by the processor or the controller, cause functions/operations specified in the flow diagrams and/or the block diagrams to be implemented. The program codes may be executed entirely on a machine, partly on a machine, as a stand-alone software package partly on a machine and partly on a remote machine or entirely on the remote machine or a server.

In the context of the disclosure, the machine-readable medium may be a tangible medium that may contain or store a program for use by or in conjunction with an instruction execution system, an apparatus, or a device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media would include electrical connections based on one or more wires, portable computer disks, hard disks, Random Access Memories (RAMs), Read Only Memories (ROMs), Erasable Programmable Read Only Memories (EPROMs or flash memories), fiber optics, portable compact disk read-only memories (CD-ROMs), optical storage devices, magnetic storage devices, or any suitable combination of the foregoing.

To provide for interaction with a user, the systems and techniques described here can be implemented on a computer, which has: a display device (for example, a CRT (cathode ray tube) or LCD (liquid crystal display) monitor) for displaying information to the user; and a keyboard and pointing device (for example, a mouse or a trackball), through which the user can provide input to the computer. Other kinds of devices may also be used to provide interaction with the user; for example, feedback provided to the user may be any form of sensory feedback (for example, visual feedback, auditory feedback, or tactile feedback); and input from the user may be received in any form (including acoustic input, voice input, or tactile input).

The systems and techniques described here may be implemented in a computing system (for example, as a data server) that includes back-end components, or a computing system (for example, an application server) that includes middleware components, or a computing system (for example, a user computer having a graphical user interface or a web browser, through which a user can interact with embodiments of the systems and techniques described here) that includes front-end components, or a computing system that includes any combination of such back-end components, middleware components, or front-end components. The components of the system can be interconnected by any form or medium of digital data communication (for example, a communication network). Examples of the communication network include: local area networks (LANs), wide area networks (WANs), the Internet, and blockchain networks.

The computer system may include clients and servers. Clients and servers are generally remote from each other and typically interact through a communication network. The relationship of client and server will be generated by computer programs running on the respective computers and having a client-server relationship to each other. The server may be a cloud server, also known as cloud computing server or cloud host, which is a host product in the cloud computing service system to solve defects such as difficult management and weak business scalability existing in the traditional physical host and the VPS service (“Virtual Private Server”, or “VPS” for short). The server may also be a server of a distributed system, or a server combined with a blockchain.

In accordance with the embodiments of this disclosure, the disclosure also provides a computer program product, including a computer program, in which the computer program, when executed by a processor, realizes a method for recognizing a category of an image described in the embodiments of this disclosure.

It should be understood that steps may be reordered, added or deleted using the various forms of flow shown above. For example, the respective steps disclosed in the disclosure may be executed in parallel, may also be executed sequentially, or may also be executed in a different order, as long as the desired result of the technical solutions disclosed in the disclosure can be achieved, and no limitation is imposed thereto herein. The specific embodiments described above do not constitute a limitation on the protection scope of the disclosure. It should be apparent to those skilled in the art that various modifications, combinations, sub-combinations and substitutions may be made depending on design requirements and other factors. Any modifications, equivalent replacements and improvements made within the spirit and the principle of the disclosure shall be included within the protection scope of the disclosure.

1. A method for recognizing a category of an image, comprising:
acquiring a spectral image, wherein the spectral image comprises a first pixel that is to be recognized and second pixels that correspond to each category and are marked as samples;
training an image recognition model based on the spectral image, wherein the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category;
determining a loss function of the image recognition model based on recognition probabilities of the second pixels, adjusting the image recognition model based on the loss function, and returning to training the adjusted image recognition model based on the spectral image until training ends to generate a target image recognition model; and
recognizing a maximum recognition probability among recognition probabilities of the first pixel under each category, output from the target image recognition model, and using a category corresponding to the maximum recognition probability as a target category corresponding to the first pixel.

2. The method according to claim 1, wherein the spectral semantic feature of each pixel is acquired by:
inputting the spectral image into a semantic extraction layer of the image recognition model, and performing semantic feature extraction on a spectrum of each pixel based on the semantic extraction layer to acquire the spectral semantic feature.

3. The method according to claim 1, wherein the minimum distance between each pixel and each category is acquired by:
acquiring any pixel, and acquiring a first distance between the any pixel and each second pixel in each category; and
for any category, acquiring a minimum value of first distances of the any category as the minimum distance between the any pixel and the any category.

4. The method according to claim 1, wherein the spectral distance between the first spectrum of each pixel and the second spectrum of each category is acquired by:
taking the first spectrum of each second pixel in each category as second spectra of the category; and
acquiring a vector distance between the first spectrum of each pixel and an average value of the second spectra of each category as the spectral distance.

5. The method according to claim 4, wherein acquiring the vector distance between the first spectrum of each pixel and the average value of the second spectra of each category as the spectral distance comprises:
performing dimensionality reduction processing on the first spectrum of each pixel to acquire a first reduced-dimensionality spectrum;
performing dimensionality reduction processing on the average value of the second spectra of each category to acquire a second reduced-dimensionality spectrum; and
acquiring the vector distance between the first reduced-dimensionality spectrum and the second reduced-dimensionality spectrum.

6. The method according to claim 5, further comprising:
performing principal component analysis (PCA) processing on the spectrum to extract a principal component from the spectrum to generate a reduced-dimensionality spectrum; wherein the spectrum comprises the first spectrum and the second spectrum, and the reduced-dimensionality spectrum comprises the first reduced-dimensionality spectrum and the second reduced-dimensionality spectrum; or,
acquiring bands corresponding to the spectrum, filtering the bands, reserving a target band, and generating a reduced-dimensionality spectrum based on a spectrum on the reserved target band.

7. An electronic device, comprising:
a processor; and
a memory communicatively connected to the processor; wherein
the memory is configured to store instructions executable by the processor, and the processor is configured to execute the instructions, to:
acquire a spectral image, wherein the spectral image comprises a first pixel that is to be recognized and second pixels that correspond to each category and are marked as samples;
train an image recognition model based on the spectral image, wherein the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category;
determine a loss function of the image recognition model based on recognition probabilities of the second pixels, adjust the image recognition model based on the loss function, and return to training the adjusted image recognition model based on the spectral image until training ends to generate a target image recognition model; and
recognize a maximum recognition probability among recognition probabilities of the first pixel under each category output from the target image recognition model, and use a category corresponding to the maximum recognition probability as a target category corresponding to the first pixel.

8. The device according to claim 7, wherein the processor is configured to execute the instructions, to:
input the spectral image into a semantic extraction layer of the image recognition model, and perform semantic feature extraction on a spectrum of each pixel based on the semantic extraction layer to acquire the spectral semantic feature.

9. The device according to claim 7, wherein the processor is configured to execute the instructions, to:
acquire any pixel, and acquire a first distance between the any pixel and each second pixel in each category; and
for any category, acquire a minimum value of first distances of the any category as the minimum distance between the any pixel and the any category.

10. The device according to claim 7, wherein the processor is configured to execute the instructions, to:
take the first spectrum of each second pixel in each category as second spectra of the category; and
acquire a vector distance between the first spectrum of each pixel and an average value of the second spectra of each category as the spectral distance.

11. The device according to claim 10, wherein the processor is configured to execute the instructions, to:
perform dimensionality reduction processing on the first spectrum of each pixel to acquire a first reduced-dimensionality spectrum;
perform dimensionality reduction processing on the average value of the second spectra of each category to acquire a second reduced-dimensionality spectrum; and
acquire the vector distance between the first reduced-dimensionality spectrum and the second reduced-dimensionality spectrum.

12. The device according to claim 11, wherein the processor is configured to execute the instructions, to:
perform principal component analysis (PCA) processing on the spectrum to extract a principal component from the spectrum to generate a reduced-dimensionality spectrum; wherein the spectrum comprises the first spectrum and the second spectrum, and the reduced-dimensionality spectrum comprises the first reduced-dimensionality spectrum and the second reduced-dimensionality spectrum; or,
acquire bands corresponding to the spectrum, filter the bands, reserve a target band, and generate a reduced-dimensionality spectrum based on a spectrum on the reserved target band.

13. A non-transitory computer-readable storage medium storing computer instructions, wherein the computer instructions are configured to cause a computer to execute a method for recognizing a category of an image, the method comprising:
acquiring a spectral image, wherein the spectral image comprises a first pixel that is to be recognized and second pixels that correspond to each category and are marked as samples;
training an image recognition model based on the spectral image, wherein the image recognition model acquires a spectral semantic feature of each pixel, a minimum distance between each pixel and each category, and a spectral distance between a first spectrum of each pixel and a second spectrum of each category; splices the spectral semantic feature, the minimum distance, and the spectral distance to acquire a spliced feature; and performs classification and recognition based on the spliced feature to output a recognition probability of each pixel under each category;
determining a loss function of the image recognition model based on recognition probabilities of the second pixels, adjusting the image recognition model based on the loss function, and returning to training the adjusted image recognition model based on the spectral image until training ends to generate a target image recognition model; and
recognizing a maximum recognition probability among recognition probabilities of the first pixel under each category, output from the target image recognition model, and using a category corresponding to the maximum recognition probability as a target category corresponding to the first pixel.

14. The non-transitory computer-readable storage medium according to claim 13, wherein the spectral semantic feature of each pixel is acquired by:
inputting the spectral image into a semantic extraction layer of the image recognition model, and performing semantic feature extraction on a spectrum of each pixel based on the semantic extraction layer to acquire the spectral semantic feature.

15. The non-transitory computer-readable storage medium according to claim 13, wherein the minimum distance between each pixel and each category is acquired by:
acquiring any pixel, and acquiring a first distance between the any pixel and each second pixel in each category; and
for any category, acquiring a minimum value of first distances of the any category as the minimum distance between the any pixel and the any category.

16. The non-transitory computer-readable storage medium according to claim 13, wherein the spectral distance between the first spectrum of each pixel and the second spectrum of each category is acquired by:
taking the first spectrum of each second pixel in each category as second spectra of the category; and
acquiring a vector distance between the first spectrum of each pixel and an average value of the second spectra of each category as the spectral distance.

17. The non-transitory computer-readable storage medium according to claim 16, wherein acquiring the vector distance between the first spectrum of each pixel and the average value of the second spectra of each category as the spectral distance comprises:
performing dimensionality reduction processing on the first spectrum of each pixel to acquire a first reduced-dimensionality spectrum;
performing dimensionality reduction processing on the average value of the second spectra of each category to acquire a second reduced-dimensionality spectrum; and
acquiring the vector distance between the first reduced-dimensionality spectrum and the second reduced-dimensionality spectrum.

18. The non-transitory computer-readable storage medium according to claim 17, wherein the method further comprises:
performing principal component analysis (PCA) processing on the spectrum to extract a principal component from the spectrum to generate a reduced-dimensionality spectrum; wherein the spectrum comprises the first spectrum and the second spectrum, and the reduced-dimensionality spectrum comprises the first reduced-dimensionality spectrum and the second reduced-dimensionality spectrum; or,
acquiring bands corresponding to the spectrum, filtering the bands, reserving a target band, and generating a reduced-dimensionality spectrum based on a spectrum on the reserved target band.
